(19) United States
(12) Patent Application Publication
(10) Pub. No.: US 2024/0116764 A1
(43) Pub. Date: Apr. 11, 2024

(54) FUMED SILICA POWDER WITH REDUCED SILANOL GROUP DENSITY

(71) Applicant: EVONIK OPERATIONS GMBH, Essen (DE)

(72) Inventors: Mareike GIESSELER, Maintal (DE); Frank MENZEL, Hanau (DE); Alexander LYGIN, Griesheim (DE); Rainer GOLCHERT, Dieburg (DE)

(73) Assignee: EVONIK OPERATIONS GMBH, Essen (DE)

(21) Appl. No.: 18/276,592

(22) PCT Filed: Jan. 19, 2022
(86) PCT No.: PCT/EP2022/051095

§ 371 Date: Aug. 9, 2023

(30) Foreign Application Priority Data
Feb. 11, 2021 (EP) 21156545.2

(51) Int. Cl. C01B 33/18; C09C 1/30; C09C 3/12

(52) U.S. Cl. CPC C01B 33/181; C09C 1/3081; C09C 3/12; C01P 2004/51; C01P 2004/61; C01P 2006/11; C01P 2006/80

(57) ABSTRACT

Process for producing fumed silica powder with a decreased silanol group density, comprising subjecting a fumed surface untreated silica powder with a silanol density d_{SiOH} of at least 1.2 SiOH/nm² and a particle size d₉₀ of not more than 10 μm, to thermal treatment at a temperature of 350° C. to 1250° C. for 5 min to 5 h, wherein the temperature and the duration of the thermal treatment are chosen so that d_{SiOH} of the silica is decreased by 10%-70% relative to d_{SiOH} of the employed thermally untreated silica, wherein the thermal treatment is carried out while the fumed silica powder is in motion, followed by optional surface treatment. Surface unmodified and modified fumed silica powders obtained by this process and the use thereof.

### FIELD OF THE INVENTION

The present invention relates to fumed silica powders with relatively small particle size and reduced silanol group density, the preparation method and the use thereof.

### BACKGROUND OF THE INVENTION

Silica powders, especially fumed silica powders, are very useful additives for a variety of different applications. To name just some of these applications, silica can be used as rheology modifying or anti-settling agents for paints, coatings, silicones, and other liquid systems. Silica powders can improve flowability of powders or optimize mechanical or optical properties of silicone compositions, as well as be used as fillers for pharmaceutical or cosmetic preparations, adhesives or sealants, toners and other compositions.

One crucial property of silica materials defining their suitability for a particular application is associated with their silanol group density, i.e. the amount of free silanol groups (SiOH) related to the surface area of silica. Untreated silicas are hydrophilic due to the presence of polar silanol groups on their surface. Silanol groups at the surface of the silicas can form hydrogen bonds with each other and with binders containing hydroxy groups, e.g. terminal dihydroxy polydimethylsiloxanes. The consequence of those filler-polymer interactions may be undesired increase in viscosity, change in the glass transition temperature and the crystallisation behaviour of the formulations with silica.

On the other hand, fumed silicas with high silanol group densities tend to absorb substantial quantities of water, increasing the moisture content of such silicas. However, in some applications, e.g. as additives in components of lithium ion batteries, e.g. in separators, electrodes, electrolyte, the presence of water is undesired. Thus, KR20150099648 discloses separator membranes coated with silica particles modified with vinyl groups, which can be used in a lithium-ion battery with a gel polymer electrolyte. Water present in such silica additives would react with some water-sensitive components of the lithium ion battery, e.g. LiPF₆ often contained in the electrolyte and lead to decomposition thereof and releasing reactive substances such as HF facilitating deactivation of such batteries. Therefore, silicas with reduced silanol density are required or may be useful for such applications, where water-sensitive components are involved.

### DESCRIPTION OF THE PRIOR ART

Depending on the nature of the hydrophilic silica, the silanol group density of about 2-15 SiOH/nm² of the surface area can be observed.

One typical approach to reduce the silanol group density of silicas is to at least partially cover the free silanol groups with organic silane groups. Thus, EP 1433749 A1 describes preparation of partially hydrophobic silicas having a silanol group density of 0.9-1.7 SiOH/nm² particle surface. The preparation of such partially hydrophobic particles is carried out by using a reduced amount of 0.015-0.15 mmol silane pro g of a silica with a BET surface area of 100 m²/g.

DE 2123233 describes a process for the preparation of finely divided silicon dioxide having a silanol group density of more than 1.18 SiOH/nm² particle surface.

DE 1767226 discloses a process for the production of finely divided silica by heating a pyrogenic silica in a fluidized bed.

Purposeful reducing of the silanol group density of hydrophilic silicas is less common.

One common method is described in U.S. Pat. No. 4,664,679, disclosing a surface treatment of silicic anhydride by reacting the silanol groups with various coupling agents.

US 2016/0355685 A1 describes a sol-gel method of preparation of silicas by hydrolysis of tetramethoxysilane followed by drying and calcination of the resulting products at 1050° C. for 1 hour in an electric furnace to provide silicas with a relatively low BET surface areas of 2-35 m²/g, grounding of the resulting coarse particles and hydrophobizing thereof with a silane.

U.S. Pat. No. 2,866,716 discloses a process of modifying the surface of a colloidal silica substrate having free silanol groups, comprising heating of the silica substrate at the temperature of 300-700° C. until its specific surface area is reduced to less than 85% of the initial value, but the silanol group density of the thermally treated silica is not less than about 2 OH/nm².

EP 1860066 A2 describes preparation of precipitated silicas with residual water content of typically 3.5 wt % and silanol group density of about 2.7 OH/nm² prepared by spray-drying of precipitated silicas followed by heating in a fluidized bed reactor at 450° C. and milling.

Both precipitated and colloidal silicas are usually prepared in aqueous media, and therefore comprise relatively high contents of water and often high silanol group densities. Such silica types are less suitable for preparing silicas with reduced silica group densities than fumed silicas. Due to their manufacturing process at high temperatures, fumed silicas have relatively low silanol group densities of typically 2.2-3.0 SiOH/nm² and are the better precursor for silicas with reduced silanol group densities.

Silanol group densities of fumed silicas can be reliably measured by a method including the reaction of the silica with lithium aluminium hydride, as described in the Journal of Colloid and Interface Science, Vol. 125, No. 1 (1988), pp 61-68. Both typical hydrophilic silicas (Aerosil®OX 50, BET=50 m²/g, Aerosil®130, BET=129 m²/g, Aerosil®150, BET=155 m²/g, Aerosil®200, BET=196 m²/g, Aerosil®300, BET=303 m²/g, Aerosil®380, BET=372 m²/g), and surface treated (hydrophobic) silicas (Aerosil®R 972, BET=102 m²/g, Aerosil®R 812, BET=245 m²/g) were analyzed using this method, indicating typical silanol group densities of about 2.0-2.5 OH/nm² for the hydrophilic silicas and 0.53-0.54 OH/nm² for the hydrophobic silicas.

From U.S. Pat. No. 3,873,337 it is known to treat the fumed silicas at 700-1000° C. in a fluidized bed with a dry inert gas stream for 1 to 60 seconds to remove physically bound water prior to a hydrophobization with dimethyldichlorosilane. Due to a very short drying time, only the weakly bound water can be removed during that step, whereas silanol-groups of silica are not affected. In fact, in this process the maximal possible silanol group density of the hydrophilic precursor is desired to achieve a high extent of hydrophobization with dimethyldichlorosilane. Thus, U.S. Pat. No. 3,873,337 does not disclose preparation of hydrophilic silica powders with reduced silanol group density.

JP 2014055072 A describes preparation of amorphous silicas with a BET surface area of 50 to 400 m²/g and silanol group densities of about 2.5 OH/nm² by a vapour phase method, e.g. a pyrogenic method. Such silica powders are mixed with a binder and a solvent, and molded bodies such as granules are formed thereof upon heating at 100-500° C. in the atmosphere of a gas containing oxygen. The thus obtained molded bodies are calcined at 600-1200° C. for 30 min-24 h to obtain mechanically stable sintered bodies in a mm-size range with a density in the range 0.55-2.09 g/cm³. JP 2014055072 A does not disclose preparation of any silica powders.

It is well known from the prior art to thermally treat compacted silica granules or fragments to obtain sintered molded bodies. Thus, WO 2009/007180 A1 discloses a process for preparing silica glass granules, wherein a fumed silica powder is compacted to slugs, which are subsequently crushed to fragments with a particle size of 100-800 μm and a tamped density of 300-600 g/L. The latter are heated at 600-1100° C. in an atmosphere suitable for removing hydroxyl groups, and further sintered at 1200-1400° C. No powders with small particle size are disclosed in this patent application.

### Problem and Solution

Good dispersibility and thixotropic properties of fumed silica fillers in various compositions, e.g. in silicones or lack compositions are of great importance for many applications. Dispersibility is primarily associated with silica particle size and their aggregation and agglomeration in the composition. Thixotropic properties of silica depend on the aggregation and agglomeration as well as silanol group density of the silica. Reducing of silanol group content upon thermal treatment, as it is known from the prior art, often goes hand in hand with a significant BET surface reduction and particle agglomeration. Thus, it is difficult to achieve substantial reducing of a silanol group density in hydrophilic silicas and simultaneously to keep the BET surface area unchanged and the silica particles small and the particle size distribution thereof narrow. Therefore, it is quite challenging to simultaneously achieve a good dispersibility of fumed silica fillers and a low viscosity increase (thickening effect) in compositions filled with such silicas.

On the other hand, moisture content of both hydrophilic and surface treated, particularly, hydrophobic fumed silicas need to be decreased for their use in some water-sensitive applications, e.g. in lithium ion batteries.

Thus, the technical problem addressed by the present invention is that of providing fumed silica powder with high dispersibility, low viscosity increase in compositions, and low moisture content, and a method suitable for manufacturing such silica powders in an efficient manner.

The present invention provides process for producing fumed silica powder, comprising step A)—subjecting a fumed surface untreated silica powder with a number of silanol groups relative to BET surface area d_{SiOH} of at least 1.2 SiOH/nm², as determined by reaction with lithium aluminium hydride and
a particle size des of not more than 10 μm, as determined by a static light scattering method (SLS) in a 5% by weight aqueous dispersion of the silica after 120 seconds of ultrasonic treatment at 25° C.,
to thermal treatment at a temperature of 350° C. to 1250° C. for 5 min to 5 h,
wherein the temperature and the duration of the thermal treatment are chosen so that d_{SiOH} of the silica is decreased by 15%-70% relative to d_{SiOH} of the employed thermally untreated silica, and
wherein the thermal treatment is carried out while the fumed silica powder is in motion.

It has been surprisingly found that the inventive process allows preparation of fumed silica powders with particularly low water contents while keeping the aggregate particle sizes thereof on very low levels, i.e. keeping the thermally treated silica particles well dispersible in various compositions. Moreover, thermally treated fumed silica particles with relatively narrow particle size distributions were obtained by this method. The obtained materials are, just like the starting materials thereof, characterized by low tamped densities. This fact allows using such thermally treated materials in all application fields where low tamped densities of fumed silicas are particularly necessary, e.g. as fillers or flowability improvers.

Process for Producing the Silica Powder

Surface Untreated Silica Employed in Step A) of the Process

The term “powder” in the context of the present invention encompass fine particles, i.e. those with an average particle size d₅₀ of typically less than 50 μm, preferably less than 10 μm.

The term “surface untreated” relates in the context of the present invention to hydrophilic silicas, which have not been surface modified by treatment with any surface treatment agents.

Such surface untreated silicas usually have low carbon contents of typically less than 1% by weight, more preferably less than 0.5% by weight, as determined by elemental analysis according to EN ISO3262-20:2000 (Chapter 8). The analysed sample is weighed into a ceramic crucible, provided with combustion additives and heated in an induction furnace under an oxygen flow. The carbon present is oxidized to CO₂. The amount of CO₂ gas is quantified by infrared detectors. The stated carbon content refers to all carbon-containing components of the silica except for non-combustible under testing conditions compounds such as e.g. silicon carbide.

Methanol wettability of such surface untreated fumed silicas is usually less than 20%, preferably less than 10%, more preferably less than 5%, more preferably about 0% by volume methanol in methanol/water mixture.

The extent of the hydrophilicity of a silica powder can be determined by its methanol wettability, as described in detail, for example, in WO2011/076518 A1, pages 5-6. In pure methanol, a hydrophilic silica powder separates completely from the methanol without being wetted with the solvent. In pure water, by contrast, a hydrophilic silica is distributed throughout the solvent volume; complete wetting takes place. During the measurement of methanol wettability of a hydrophilic silica powder, a tested silica sample is mixed with different methanol/water mixtures and a maximum methanol content at which there is still no separation of the silica, i.e. 100% of the silica used remains well distributed in the test mixture, is determined. This methanol content in the methanol/water mixture in % by volume is called methanol wettability. The lower the methanol wettability, the higher the hydrophilicity of the tested silica powder.

The fumed surface untreated silica employed in step A) of the inventive process preferably has a number of silanol groups relative to BET surface area d_{SiOH} of at least 1.3 SiOH/nm², more preferably at least 1.4 SiOH/nm², more preferably at least 1.5 SiOH/nm², more preferably 1.5-3.0 SiOH/nm², as determined by reaction with lithium aluminium hydride.

The number d_{SiOH} of silanol groups relative to BET surface area, also referred to as silanol group density, expressed in number of SiOH-groups per nm², can be determined by the method described in detail on page 8, line 17 thru page 9, line 12 of EP 0725037 A1 by reaction of the silica powder with lithium aluminium hydride. This method is also described in Journal of Colloid and Interface Science, vol. 125, no. 1, (1988), pp. 61-68.

The silanol (SiOH) groups of the silica are reacted with lithium aluminium hydride (LiAlH₄), the quantity of gaseous hydrogen formed during this reaction and thus the amount of silanol groups in the sample n_{SiOH} (in mmol SiOH/g) is determined. Using the corresponding BET surface area (in m²/g) of the tested material, the silanol group content in mmol SiOH/g can easily be converted in the number d_{SiOH} of silanol groups relative to BET surface area:

d_{SiOH}[SiOH/nm²]=(n_{SiOH}[mmol SiOH/g]×N_{A})/(BET[m²/g]×10²¹),
wherein N_{A} is Avogadro number (˜6.022*10²³).

The fumed surface untreated silica employed in step A) of the inventive process can have a BET surface area of greater than 20 m²/g, preferably of 20 m²/g to 600 m²/g, more preferably of 30 m²/g to 500 m²/g, more preferably of 40 m²/g to 400 m²/g. The specific surface area, also referred to simply as BET surface area, can be determined according to DIN 9277:2014 by nitrogen adsorption in accordance with the Brunauer-Emmett-Teller method.

The term “silica” in the context of the present invention relates to the individual compound (silicon dioxide, SiO₂), silica-based mixed oxides, silica-based doped oxides, or mixtures thereof. “Silica-based” means that the corresponding silica material comprises at least 70% by weight, preferably at least 80% by weight, more preferably at least 90% by weight, more preferably at least 95% by weight, most preferably at least 98% by weight of silicon dioxide.

“Fumed” silicas also known as “pyrogenic” or “pyrogenically produced” silicas, are prepared by means of pyrogenic processes, such as flame hydrolysis or flame oxidation.

This involves oxidizing or hydrolysing of hydrolysable or oxidizable starting materials, generally in a hydrogen/oxygen flame. Starting materials used for pyrogenic methods include organic and inorganic substances. Silicon tetrachloride is particularly suitable. The hydrophilic silica thus obtained is amorphous. Fumed silicas are generally in aggregated form. “Aggregated” is understood to mean that what are called primary particles, which are formed at first in the genesis, become firmly bonded to one another later in the reaction to form a three-dimensional network. The primary particles are substantially free of pores and have free hydroxyl groups on their surface. Such hydrophilic silicas can, as required, be hydrophobized, for example by treatment with reactive silanes.

It is known to produce pyrogenic mixed oxides by simultaneously reacting at least two different metal sources in the form of volatile metal compounds, for example chlorides, in a H₂/O₂ flame. All components of thus prepared mixed oxides, are generally distributed homogeneously in the whole mixed oxide material as opposed to the other kinds of materials like mechanical mixtures of several metal oxides, doped metal oxides and suchlike. In the latter case, e.g. for the mixture of several metal oxides, separated domains of the corresponding pure oxides may be present, which determine the properties of such mixtures.

The surface untreated fumed silica powder employed in the inventive process can have an average primary particle size d₅₀ of 5 nm to 50 nm, preferably 5 nm to 40 nm. The average size of primary particles d₅₀ can be determined by transmission electron microscopy (TEM) analysis. At least 100 particles should be analysed to calculate a representative average value of d₅₀.

The surface untreated fumed silica powder employed in the inventive process has particle size d₉₀ of not more than 10 μm, preferably not more than 5 μm, more preferably not more than 3 μm, more preferably not more than 2 μm, preferably not more than 1 μm, as determined by static light scattering (SLS) after 120 s of ultrasonic treatment at 25° C. of a 5% by weight dispersion of the silica in water. The resulting measured particle size distribution is used to define the value d₉₀, which reflects the particle size not exceeded by 90% of all particles. The above-mentioned particle size d₉₀ refers to the particle size of the aggregated and agglomerated fumed silica particles.

The surface untreated fumed silica powder employed in the inventive process preferably has a relatively narrow particle size distribution, which can be characterized by a value of span (d₉₀−d₁₀)/d₅₀ of particle size distribution of not more than 3.5, preferably 0.7-3.5, more preferably 0.8-3.5, more preferably 1.0-3.2, more preferably 1.1-3.1, more preferably 1.2-3.0.

The surface untreated fumed silica powder employed in the inventive process preferably has a tamped density of not more than 300 g/L, more preferably of not more than 250 g/L, more preferably of 20 g/L to 250 g/L, more preferably of 20 g/L to 200 g/L, more preferably of 25 g/L to 180 g/L, more preferably of 30 g/L to 150 g/L. Tamped densities (also referred to as “tapped density”) of various pulverulent or coarse-grain granular materials can be determined according to DIN ISO 787-11:1995 “General methods of test for pigments and extenders—Part 11: Determination of tamped volume and apparent density after tamping”. This involves measuring the apparent density of a bed after agitation and tamping.

The surface untreated fumed silica powder employed in the inventive process preferably has a water content of not more than 3% by weight, more preferably not more than 2% by weight, more preferably not more than 1.5% by weight, more preferably not more than 1.2% by weight, as determined by Karl Fischer titration method. This Karl Fischer titration may be performed using any suitable Karl Fischer titrator, e.g. according to STN ISO 760.

Thermal Treatment

Thermal treatment of the surface untreated fumed silica powder in the inventive process is conducted at a temperature of 350° C. to 1250° C., preferably at 400° C.-1250° C., more preferably at 400° C.-1200° C., more preferably at 500° C.-1200° C., more preferably at 700° C.-1200° C., more preferably at 1000° C.-1200° C. The duration of this thermal treatment depends on the temperature applied, and is generally from 5 minutes to 5 hours, preferably from 10 minutes to 4 hours, more preferably from 20 minutes to 3 hours, more preferably from 30 minutes to 2 hours.

It has been observed that the duration of the thermal treatment step may greatly impact the properties of the obtained fumed silica powders. Thus, if the duration of the thermal treatment step carried out at 350-1250° C. is less than 5 minutes, usually no significant reducing in moisture content of the silica is observed, especially if the starting material for thermal treatment is pre-dried prior to thermal treatment and as such is not wet and e.g. has a water content of not more than 3% by weight, as determined by Karl Fischer titration method. Conversely, the duration of the thermal treatment step of more than 5 hours usually does not bring about any significant further change in the water content of the obtained silica, while particle size of the obtained particles may become larger.

Thermal treatment in the inventive process apparently leads to reducing the number of free silanol groups by condensation of such groups and formation of O—Si—O bridges.

Temperature and the duration of the thermal treatment step are chosen so that d_{SiOH} of the silica is decreased by 10%-70% relative to d_{SiOH} of the employed thermally and surface untreated fumed silica powder. Thus, the fumed silica powder prepared by a process of the present invention has a number of silanol groups relative to BET surface area d_{SiOH} of not more than 1.55 SiOH/nm², preferably 0.6 SiOH/nm²-1.55 SiOH/nm², more preferably 0.6 SiOH/nm²-1.5 SiOH/nm², more preferably 0.6 SiOH/nm²-1.4 SiOH/nm², more preferably 0.6 SiOH/nm²-1.3 SiOH/nm², more preferably 0.6 SiOH/nm²-1.2 SiOH/nm², more preferably 0.7 SiOH/nm²-1.2 SiOH/nm², more preferably 0.8 SiOH/nm²-1.2 SiOH/nm², more preferably 0.9 SiOH/nm²-1.2 SiOH/nm², as determined by reaction with lithium aluminium hydride.

It has been found that the decrease of the silanol density by less than 10% of the original value of d_{SIOH} for the silica employed in step A) of the inventive process is not associated with substantial reduce in moisture content of the silica or any other beneficial effects. On the other hand, the decrease of the silanol group density by more than 70% is only possible with simultaneous formation of larger sintered agglomerates, which cannot be easily destroyed, e.g. by ultrasonic treatment.

Importantly, in contrast to the silanol density, the BET surface area of the thermally treated silica is usually changed only to a relatively small extent during carrying out step A) of the inventive process. Thus during the thermal treatment, BET surface area of the fumed silica powder is preferably decreased by at most 50%, more preferably by at most 45%, more preferably by at most 40%, more preferably by at most 35% relative to the BET surface area of the thermally and surface untreated silica employed in step A) of the inventive process.

Thermal treatment in the inventive process may be carried out discontinuously (batchwise), semi-continuously or preferably continuously.

The “duration of the thermal treatment” of a discontinuous process is defined as a whole period of time when the surface untreated fumed silica is being heated at the specified temperature. For a semi-continuous or continuous process, the “duration of the thermal treatment” corresponds to the mean residence time of the surface untreated fumed silica powder at the specified temperature of thermal treatment.

The inventive process is preferably carried out continuously, with the mean residence time of the surface untreated fumed silica powder in the thermal treatment step A) of from 10 min to 3 h.

In the inventive process, thermal treatment is carried out while the fumed silica powder is in motion, preferably in constant motion during the process, i.e. silica is being moved during the thermal treatment. Such a “dynamic” process is an opposite of a “static” thermal treatment process, wherein silica particles are not moved, e.g. are present in layers during a thermal treatment e.g. in a muffle furnace.

It has been surprisingly found that such a dynamic thermal treatment process in combination with suitable temperature and duration of the thermal treatment allows producing of small particles with a narrow particle size distribution showing particularly good dispersibility in various compositions. In contrast, a “static” thermal treatment without any motion of the silica was found to lead to sintered aggregates with much larger particle sizes, those dispersibility in compositions is much worse.

The inventive process can be carried out in any suitable apparatus allowing keeping the silica powder at the above-specified temperature for a specified period of time, while moving the silica. Some suitable apparatuses are fluidized bed reactors and rotary kilns. Rotary kilns, particularly those with a diameter of 1 cm to 2 m, preferably 5 cm to 1 m, more preferably 10 cm to 50 cm, are preferably used in the inventive process.

The silica powder is preferably being moved at the motion rate of a least 1 cm/min, more preferably at least 10 cm/min, more preferably at least 25 cm/min, more preferably at least 50 cm/min, at least temporally during the thermal treatment step A). Preferably, the silica is being moved at this motion rate continuously for the whole duration of the thermal treatment step. The motion rate in a rotary kiln corresponds to circumferential speed of this reactor type. The motion rate in a fluidized bed reactor corresponds to the carrier gas flow rate (fluidization velocity).

It is further preferable, that essentially no water is added before, during or after carrying out step A) of the inventive process. More preferably no water is added before, during or after carrying out step A) of the inventive process. In this way, the additional evaporation of the absorbed water is avoided and thermally treated silica powders with a lower water content may be obtained.

The thermal treatment step A) can be conducted under flow of a gas, such as, for example, air or nitrogen, the gas preferably being essentially free of water or pre-dried.

“Essentially free of water” means with respect to the gas that the humidity of the gas does not exceed its humidity under the employed conditions such as the temperature and the pressure, i.e. no steam or water vapour is added to the gas prior to use. Water content of the gas used in step A) of the inventive process, is preferably less than 5% by volume, more preferably less than 3% by volume, more preferably less than 1% by volume, more preferably less than 0.5% by volume.

Surface Treatment

The inventive process for producing fumed silica powder can further comprise
step B)—surface treatment of the of the fumed silica powder obtained in step A) with a surface treatment agent selected from the group consisting of organosilanes, silazanes, acyclic polysiloxanes, cyclic polysiloxanes, and mixtures thereof.

The preferred organosilanes are e.g. alkyl organosilanes of the general formulas (Ia) and (Ib):

R′ₓ(RO)_{y}Si(CₙH₂ₙ₊₁) (Ia)

R′ₓ(RO)_{y}Si(CₙH₂ₙ₋₁) (Ib)
wherein
R=alkyl, such as, for example, methyl-, ethyl-, n-propyl-, i-propyl-, butyl-
R′=alkyl or cycloalkyl, such as, for example, methyl, ethyl, n-propyl, i-propyl, butyl, cyclohexyl, octyl, hexadecyl.
n=1-20
x+y=3
x=0-2, and
y=1-3.

Among alkyl organosilanes of formulas (Ia) and (Ib), particularly preferred are octyltrimethoxysilane, octyltriethoxysilane, hexadecyltrimethoxysilane, hexadecyltriethoxysilane.

Organosilanes used for surface treatment may contain halogens such as Cl or Br. Particularly preferred are the halogenated organosilanes of the following types:
organosilanes of the general formulas (IIa) and (IIb):

X₃Si(CₙH₂ₙ₊₁) (IIa)

X₃Si(CₙH₂ₙ₋₁) (IIb),
wherein X═Cl, Br, n=1-20;
organosilanes of the general formulas (IIIa) and (IIIb):

X₂(R′)Si(CₙH₂ₙ₊₁) (IIIa)

X₂(R′)Si(CₙH₂ₙ₋₁) (IIIb),
wherein X═Cl, Br
R′=alkyl, such as, for example, methyl, ethyl, n-propyl, i-propyl, butyl, cycloalkyl such as cyclohexyl
n=1-20;
organosilanes of the general formulas (IVa) and (IVb):

X(R′)₂Si(CₙH₂ₙ₊₁) (IVa)

X(R′)₂Si(CₙH₂ₙ₋₁) (IVb),
wherein X═Cl, Br
R′=alkyl, such as, for example, methyl, ethyl, n-propyl, i-propyl, butyl, cycloalkyl such as cyclohexyl
n=1-20
Among halogenated organosilanes of formula (II)-(IV), particularly preferred are dimethyldichlorosilane and chloro trimethylsilane.

The used organosilanes can also contain other than alkyl or halogen substituents, e.g. fluorine substituents or some functional groups. Preferably used are functionalized organosilanes of the general formula (V):

(R″)ₓ(RO)_{y}Si(CH₂)ₘR′ (V),
wherein
R″=alkyl, such as methyl, ethyl, propyl, or halogen such as Cl or Br,
R=alkyl, such as methyl, ethyl, propyl,
x+y=3
x=0-2,
y=1-3,
m=1-20,
R′=methyl-, aryl (for example, phenyl or substituted phenyl residues), heteroaryl —C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR¹R²R³ (R¹=alkyl, aryl; R²═H, alkyl, aryl; R³═H, alkyl, aryl, benzyl, C₂H₄NR⁴R⁵ with R⁴═H, alkyl and R⁵═H, alkyl).

Among functionalized organosilanes of formula (V), particularly preferred are 3-methacryloxypropyltrimethoxysilane, 3-methacryloxypropyltriethoxysilane, glycidyloxypropyltrimethoxysilane, glycidyloxypropyltriethoxysilane, aminopropyltriethoxysilane.

Silazanes of the general formula R′R₂Si—NH—SiR₂R′ (VI), wherein R=alkyl, such as methyl, ethyl, propyl; R′=alkyl, vinyl, are also suitable as a surface treatment agents. The most preferred silazane of formula (VI) is hexamethyldisilazane (HMDS).

Also suitable as surface treatment agents are cyclic polysiloxanes, such as octamethylcyclotetrasiloxane (D4), decamethylcyclopentasiloxane (D5), dodecamethylcyclohexasiloxane (D6), hexamethylcyclotrisiloxane (D6). Most preferably among cyclic polysiloxanes, D4 is used.

Another useful type of surface treatment agents is polysiloxanes or silicone oils of the general formula (VII):

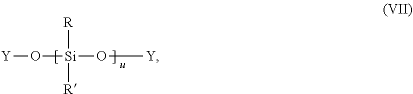

wherein
Y═H, CH₃, CₙH₂ₙ₊₁, wherein n=1-20, Si(CH₃)ₐX_{b},
wherein a=2-3, b=0 or 1, a+b=3,
X═H, OH, OCH₃, CₘH₂ₘ₊₁, wherein m=1-20.
R, R′=alkyl, such as CoH₂ₒ₊₁, wherein o=1 to 20, aryl, such as phenyl and substituted phenyl residues, heteroaryl, (CH₂)ₖ—NH₂, wherein k=1-10, H,
u=2-1000, preferably u=3-100.

Most preferably among polysiloxanes and silicone oils of the formula (VII), polydimethylsiloxanes are used as surface treatment agents. Such polydimethylsiloxanes usually have a molar mass of 162 g/mol to 7500 g/mol, a density of 0.76 g/mL to 1.07 g/mL and viscosities of 0.6 mPa*s to 1 000 000 mPa*s.

Water can be used additionally to the surface treatment agent in step B) of the inventive process. The molar ratio of water to the surface treatment agent in step B) of the inventive process is preferably from 0.1 to 100, more preferably 0.5 to 50, more preferably 1.0 to 10, more preferably 1.2 to 9, more preferably 1.5 to 8, more preferably 2 to 7.

However, if a surface treated silica powder with a low water content should be obtained, the amount of used in process water should be minimized and ideally no water at all should be added during the process steps. Thus, essentially no water is preferably added before, during or after carrying out step B). The term “essentially no water” relates in the context of the present invention to added water amount of less than 1%, preferably less than 0.5%, more preferably less than 0.1%, more preferably less than 0.01% by weight of the employed in step B) fumed silica powder, most preferably no water at all.

The surface treatment agent and optionally water can be used both in vapour and liquid form in the inventive process.

Step B) of the inventive process can be carried out at a temperature of 10° C. to 250° C. for 1 minute to 24 hours. The time and the duration of step B) can be selected according to the specific requirements for the process and/or targeted silica properties. Thus, the lower treatment temperature usually requires the longer hydrophobization times. In one preferred embodiment of the invention, hydrophobizing of the fumed silica powder is performed at 10° C. to 80° C. for 3 hours to 24 hours, preferably for 5 hours to 24 hours. In another preferred embodiment of the invention, step B) of the process is carried out at 90° C. to 200° C., preferably at 100° C. to 180° C., most preferably at 120° C. to 160° C. for 0.5 hours to 10 hours, preferably for 1 hours to 8 hours. Step B) of the process according to the invention can be carried out under the pressure of 0.1 bar to 10 bar, preferably under 0.5 bar to 8 bar, more preferably at 1 bar to 7 bar, most preferably under 1.1 bar to 5 bar. Most preferably, step B) is performed in a closed system under natural vapour pressure of the used surface treatment agent at the reaction temperature.

In step B) of the inventive process, the fumed silica powder subjected to thermal treatment in step A) is preferably sprayed with a liquid surface treatment agent at ambient temperature (about 25° C.) and the mixture is subsequently treated thermally at a temperature of 50° C. to 400° C. over a period of 1 hours to 6 hours.

An alternative method for surface treatment in step B) can be carried out by treating the fumed silica powder subjected to thermal treatment in step A) with a surface treatment agent, with the surface treatment agent being in the vapour form and subsequently treating the mixture thermally at a temperature of 50° C. to 800° C. over a period of 0.5 hours to 6 hours.

The thermal treatment after the surface treatment in step B) can be conducted under protective gas, such as, for example, nitrogen. The surface treatment can be carried out in heatable mixers and dryers with spraying devices, either continuously or batchwise. Suitable devices can be, for example, ploughshare mixers or plate, cyclone, or fluidized bed dryers.

The amount of the surface treatment agent used depends on the type of the particles and of the surface treatment agent applied. However, usually from 1% to 25%, preferably 2%-20%, more preferably 5%-18%, by weight of the surface treatment agent related to the amount of the fumed silica powder subjected to thermal treatment in step A), is employed.

The required amount of the surface treatment agent can depend on the BET surface area of the fumed silica powder employed. Thus, preferably, 0.1 μmol-100 μmol, more preferably 1 μmol-50 μmol, more preferably 3.0 μmol-20 μmol of the surface treatment agent per m² of the BET specific surface area of the fumed silica powder subjected to thermal treatment in step A), is employed.

In optional step C) of the inventive process, the fumed silica powder subjected to thermal treatment in step A) and/or the fumed silica powder obtained in step B) of the process is crushed or milled to reduce the mean particle size of the obtained silica particles.

Crushing in optional step C) of the inventive processes can be realized by means of any suitable for this purpose machine, e.g. by a suitable mill.

However, in most cases, carrying out the optional step C) of the inventive process is unnecessary and even not desirable. Though crushing or milling of coarse silica particles usually provides silica particles with reduced mean particle sizes, yet such particles show relatively broad particle size distributions. Such particles usually contain relatively large ratios of fines, complicating handling of these crushed/milled particles.

Therefore, the inventive process preferably does not contain any crushing and/or milling steps.

Surface Unmodified Fumed Silica Powder

The invention further provides surface unmodified silica powder obtained by the inventive process.

The invention further provides surface unmodified silica powder, that can, preferably is prepared according to the inventive process, having:
a) a number of silanol groups relative to BET surface area d_{SiOH} of not more than 1.17 SiOH/nm², preferably 0.6 SiOH/nm²-1.15 SiOH/nm², more preferably 0.6 SiOH/nm²-1.14 SiOH/nm², more preferably 0.6 SiOH/nm²-1.1 SiOH/nm², more preferably 0.6 SiOH/nm²-1.05 SiOH/nm², more preferably 0.6 SiOH/nm²-1.05 SiOH/nm², more preferably 0.7 SiOH/nm²-1.05 SiOH/nm², more preferably 0.8 SiOH/nm²-1.05 SiOH/nm², more preferably 0.9 SiOH/nm²-1.05 SiOH/nm², as determined by reaction with lithium aluminium hydride;
b) particle size d₉₀ of not more than 10 μm, preferably not more than 5 μm, more preferably not more than 3 μm, more preferably not more than 2 μm, preferably not more than 1 am, as determined by static light scattering (SLS) after 120 s of ultrasonic treatment at 25° C. of a 5% by weight dispersion of the silica in water. The resulting measured particle size distribution is used to define the d₉₀ value, which reflects the particle size not exceeded by 90% of all particles.

This inventive surface unmodified silica powder characterized by features a) and b) can be obtained by the above-described inventive process.

The above-mentioned surface unmodified fumed silica powder is not surface treated, i.e. it is not modified with any surface treatment agent and is therefore hydrophilic in nature.

The surface unmodified fumed silica powder according to the invention preferably has a carbon content of less than 1.0% by weight, preferably less than 0.5% by weight, more preferably less than 0.3% by weight, more preferably less than 0.2% by weight, even more preferably less than 0.1% by weight, still even more preferably less than 0.05% by weight. The carbon content can be determined by elemental analysis according to EN ISO3262-20:2000 (Chapter 8).

The surface unmodified fumed silica powder according to the invention preferably has a water content of less than 1.0% by weight, more preferably less than 0.7% by weight, more preferably less than 0.5% by weight, more preferably less than 0.4% by weight, more preferably less than 0.3% by weight, more preferably less than 0.2% by weight. The water content can be determined by Karl Fisher titration method.

The surface unmodified fumed silica powder of the present invention preferably has a methanol wettability of not more than 15% by volume, more preferably of not more than 10% by volume, more preferably of not more than 5% by volume, especially preferably of about 0% by volume of methanol in a methanol/water mixture. Methanol wettability of the surface unmodified fumed silica powder can be determined, as described in detail, for example, in WO2011/076518 A1, pages 5-6.

The surface unmodified fumed silica powder according to the present invention preferably has a numerical median particle size d₅₀ of up to 2 μm, more preferably from 0.05 μm to 1.5 μm, more preferably from 0.10 μm to 1.2 μm, more preferably from 0.15 μm to 1.0 am, more preferably from 0.20 μm to 0.90 μm, more preferably from 0.25 μm to 0.80 am, as determined by static light scattering (SLS) after 120 s of ultrasonic treatment at 25° C. of a 5% by weight dispersion of the silica in water. The resulting measured particle size distribution is used to define the median d₅₀, which reflects the particle size not exceeded by 50% of all particles, as the numerical median particle size.

The surface unmodified fumed silica powder of the invention preferably has a relatively narrow particle size distribution, which can be characterized by a value of span (d₉₀−d₁₀)/d₅₀ of particle size distribution of less than 7.0, less than 4.0, more preferably 0.8-3.5, more preferably 0.9-3.2, more preferably 1.0-3.1, more preferably 1.0-3.0, more preferably 1.0-2.5, more preferably 1.0-2.0. Hydrophilic silica powder with such a narrow particle size distribution has particularly good dispersibility in various compositions and is therefore preferential.

The surface unmodified fumed silica powder of the invention preferably has a tamped density of not more than 300 g/L, more preferably of not more than 250 g/L, more preferably of 20 g/L to 250 g/L, more preferably of 20 g/L to 200 g/L, more preferably of 25 g/L to 180 g/L, more preferably of 30 g/L to 150 g/L. Tamped densities can be determined according to DIN ISO 787-11:1995.

The surface unmodified fumed silica powder of the invention can have a BET surface area of greater than 20 m²/g, preferably of 20 m²/g to 600 m²/g, more preferably of 30 m²/g to 500 m²/g, more preferably of 40 m²/g to 400 m²/g, more preferably of 50 m²/g to 300 m²/g. The specific surface area, also referred to simply as BET surface area, can be determined according to DIN 9277:2014 by nitrogen adsorption in accordance with the Brunauer-Emmett-Teller method.

The surface unmodified fumed silica powder according to the invention can be obtained after carrying out step A) of the inventive process, preferably the surface unmodified fumed silica powder according to the invention is obtained by carrying out step A) of the inventive process.

Surface Modified Fumed Silica Powder

The invention further provides surface modified fumed silica powder obtainable by steps A) and B) of the inventive process, preferably the surface modified fumed silica powder according to the invention is obtained by carrying out steps A) and B) of the inventive process.

The invention further provides surface modified fumed silica powder having:
a) a number of silanol groups relative to BET surface area d_{SiOH} of not more than 0.29 SiOH/nm², as determined by reaction with lithium aluminium hydride;
b) particle size d₉₀ of not more than 10 μm, as determined by static light scattering (SLS) after 120 s of ultrasonic treatment at 25° C. of a 5% by weight dispersion of the surface treated silica in methanol.

Such surface modified fumed silica powder according to the invention characterized by features a) and b) can be obtained by the inventive process comprising steps A) and B) of the inventive process.

In the present invention, the term “surface modified” is used in analogy to the term “surface treated” and relates to a chemical reaction of the surface untreated hydrophilic silica with the corresponding surface treatment agent, which fully or partially modify free silanol groups of silica.

This surface treatment agent can be selected from the group consisting of organosilanes, silazanes, acyclic polysiloxanes, cyclic polysiloxanes, and mixtures thereof. Preferably, organosilanes, silazanes or mixtures thereof are used in the process. Some particularly useful surface treatment agents are identical with those described above for the surface treatment step B) of the inventive process.

The surface modified fumed silica powder of the present invention, that can, preferably is prepared according to the inventive process, has a number of silanol groups relative to BET surface area d_{SiOH} of not more than 0.45 SiOH/nm², preferably not more than 0.43 SiOH/nm², more preferably not more than 0.41 SiOH/nm², more preferably not more than 0.39 SiOH/nm², more preferably not more than 0.37 SiOH/nm², more preferably not more than 0.35 SiOH/nm², more preferably not more than 0.33 SiOH/nm², more preferably not more than 0.31 SiOH/nm², more preferably not more than 0.29 SiOH/nm² more preferably not more than 0.28 SiOH/nm², more preferably not more than 0.25 SiOH/nm², more preferably not more than 0.20 SiOH/nm². Particularly preferably, the surface modified fumed silica powder of the present invention can have a number of silanol groups relative to BET surface area d_{SiOH} of more than 0.02 SiOH/nm², more preferably 0.02 SiOH/nm²-0.45 SiOH/nm², more preferably 0.03 SiOH/nm²-0.40 SiOH/nm², more preferably 0.05 SiOH/nm²-0.35 SiOH/nm², more preferably 0.05 SiOH/nm²-0.33 SiOH/nm², more preferably 0.05 SiOH/nm²-0.30 SiOH/nm², more preferably 0.03 SiOH/nm²-0.29 SiOH/nm², more preferably 0.05 SiOH/nm²-0.28 SiOH/nm², more preferably 0.05 SiOH/nm²-0.25 SiOH/nm², more preferably 0.07 SiOH/nm²-0.20 SiOH/nm², more preferably 0.10 SiOH/nm²-0.20 SiOH/nm².

The silanol group density of the inventive surface modified fumed silica powder is unprecedently low comparing to the typical surface treated fumed silicas. This results in unique properties of such silicas, e.g. a decreased moisture content of such surface treated silicas.

The surface modified silica powder of the invention can be hydrophilic or hydrophobic, depending on the chemical structure of the used surface treatment agent. Preferably, surface treatment agents imparting hydrophobic properties are used leading to the formation of the surface treated silica powder with hydrophobic properties.

The term “hydrophobic” in the context of the present invention relates to the surface-treated silica particles having a low affinity for polar media such as water. The extent of the hydrophobicity of the surface treated silica powder can be determined via parameters including its methanol wettability, as described in detail, for example, in WO2011/076518 A1, pages 5-6. In pure water, a hydrophobic silica separates completely from the water and floats on the surface thereof without being wetted with the solvent. In pure methanol, by contrast, a hydrophobic silica is distributed throughout the solvent volume; complete wetting takes place. In the measurement of methanol wettability, the tested silica sample is mixed with different methanol/water mixtures and a maximum methanol content at which there is still no wetting of the silica, i.e. 100% of the tested silica remains separated from the test mixture, is determined. This methanol content in the methanol/water mixture in % by volume is called methanol wettability. The higher the level of such methanol wettability, the more hydrophobic the silica.

The surface modified fumed silica powder of the present invention preferably has a methanol wettability of methanol content greater than 20% by volume, more preferably of 30% to 90% by volume, more preferably of 30% to 80% by volume, especially preferably of 35% to 75% by volume, most preferably of 40% to 70% by volume in a methanol/water mixture.

The inventive surface modified fumed silica powder has particle size d₉₀ of not more than 10 μm, preferably not more than 5 μm, more preferably not more than 3 μm, more preferably not more than 2 μm, more preferably not more than 1 μm, as determined by static light scattering (SLS) after 120 s of ultrasonic treatment at 25° C. of a 5% by weight dispersion of the silica in methanol. The resulting measured particle size distribution is used to define the value d₉₀, which reflects the particle size not exceeded by 90% of all particles.

The surface modified fumed silica powder according to the present invention preferably has a numerical median particle size d₉₀ of up to 2 μm, more preferably from 0.05 μm to 1.5 μm, more preferably from 0.10 μm to 1.2 μm, more preferably from 0.15 μm to 1.0 μm, more preferably from 0.20 μm to 0.90 μm, more preferably from 0.25 μm to 0.80 μm, as determined by static light scattering (SLS) after 120 s of ultrasonic treatment at 25° C. of a 5% by weight dispersion of the silica in methanol. The resulting measured particle size distribution is used to define the median d₅₀, which reflects the particle size not exceeded by 50% of all particles, as the numerical median particle size.

The surface modified fumed silica powder of the invention preferably has a relatively narrow particle size distribution, which can be characterized by a value of span (d₉₀-d₁₀)/d₉₀ of particle size distribution of not more than 7.0, more preferably not more than 4.0, more preferably not more than 3.5, preferably 0.7-3.5, more preferably 0.8-3.5, more preferably 1.0-3.2, more preferably 1.1-3.1, more preferably 1.2-3.0. Surface modified fumed silica powder with such a narrow particle size distribution has particularly good dispersibility in various compositions and is therefore preferential.

The surface modified fumed silica powder of the invention can have a BET surface area of greater than 15 m²/g, preferably of 15 m²/g to 500 m²/g, more preferably of 30 m²/g to 400 m²/g, more preferably of 40 m²/g to 300 m²/g, more preferably of 50 m²/g to 250 m²/g.

The surface modified fumed silica powder of the invention preferably has a tamped density of more than 10 g/L, more preferably of 20 g/L to 300 g/L, more preferably of 25 g/L to 250 g/L, more preferably of 30 g/L to 220 g/L, more preferably of 35 g/L to 200 g/L, more preferably of 40 g/L to 150 g/L, more preferably of 45 g/L to 120 g/L, more preferably of 50 g/L to 100 g/L. Tamped density can be determined according to DIN ISO 787-11:1995.

The surface modified fumed silica powder according to the invention can have a carbon content of from 0.2% to 10% by weight, preferably from 0.3% to 7% by weight, more preferably from 0.4% to 5% by weight, more preferably from 0.5% to 4% by weight, more preferably from 0.5% to 3.5% by weight, more preferably from 0.5% to 3.2% by weight, more preferably from 0.5% to 3.0% by weight, more preferably from 0.5% to 2.5% by weigh, more preferably from 0.5% to 2.0% by weigh, more preferably from 0.5% to 1.5% by weigh as determined by elemental analysis. Elemental analysis can be performed according to EN ISO3262-20:2000 (Chapter 8). The analysed sample is weighed into a ceramic crucible, provided with combustion additives and heated in an induction furnace under an oxygen flow. The carbon present is oxidized to CO₂. The amount of CO₂ gas is quantified by infrared detectors.

Particularly preferably, the surface modified fumed silica powder according to the invention is characterized by a very low carbon content, such as from 0.5% to 3.5% by weight, more preferably from 0.5% to 3.0% by weight or even from 0.5% to 2.0% by weight which is however sufficient for achieving a high extent of surface treatment, e.g. high degree of hydrophobicity of such surface treated fumed silicas of e.g. 30% to 80% by volume, more preferably of 35% to 75% by volume, more preferably of 40% to 70% by volume in a methanol/water mixture. In such surface treated fumed silica powders, a minimal amount of a surface treatment agent is used for achieving the maximal degree of surface treatment, e.g. maximal degree of hydrophobicity of the silica powder.

Also particularly preferably, the surface modified fumed silica powder according to the invention has a low carbon content, such as from 0.5% to 3.5% by weight, more preferably from 0.5% to 3.0% by weight or even from 0.5% to 2.0% by weight in combination with a low number of silanol groups relative to BET surface area d_{SiOH} such as not more than 0.35 SiOH/nm², more preferably not more than 0.30 SiOH/nm², more preferably not more than 0.25 SiOH/nm². In this case, the lowest possible water content of surface treated fumed silicas can be achieved by using the minimal amount of a surface treatment agent.

Loss on drying (LOD) of the surface modified fumed silica powder of the invention is preferably less than 5.0 wt %, more preferably less than 3.0 wt %, more preferably less than 2.0 wt %, more preferably less than 1.0 wt %, more preferably less than 0.8 wt %, more preferably less than 0.5 wt %. Loss on drying can be determined according to ASTM D280-01 (method A).

The surface modified fumed silica powder according to the invention preferably has a water content of less than 0.8% by weight, more preferably less than 0.6% by weight, more preferably less than 0.4% by weight, more preferably less than 0.3% by weight, more preferably less than 0.2% by weight, more preferably less than 0.1% by weight. The water content can be determined by Karl Fisher titration method.

Composition Comprising the Fumed Silica Powder

Another object of the present invention is composition comprising the inventive surface unmodified fumed silica powder and/or the inventive surface modified fumed silica powder according to the invention.

The composition according to the invention can comprise at least one binder, which joins the individual parts of the composition to one another and optionally to one or more fillers and/or other additives and can thus improve the mechanical properties of the composition. Such a binder can contain organic or inorganic substances. The binder optionally contains reactive organic substances. Organic binders can, for example, be selected from the group consisting of (meth)acrylates, alkyd resins, epoxy resins, gum Arabic, casein, vegetable oils, polyurethanes, silicone resins, wax, cellulose glue and mixtures thereof. Such organic substances can lead to the curing of the composition used, for example by evaporation of the solvents, polymerization, crosslinking reaction or another type of physical or chemical transformation. Such curing can take place, for example, thermally or under the action of UV radiation or other radiation. Both single (one) component (1-C) and multicomponent systems, particularly two component systems (2-C) can be applied as binder. Particularly preferred for the present invention are water based or miscible with water (meth)acrylate-based binders and epoxy resins (preferably as two-component systems).

In addition to the organic binder or as an alternative thereto, the composition of the invention can contain inorganic curable substances. Such inorganic binders, also referred to as mineral binders, have essentially the same task as the organic binders, that of joining additive substances to one another. Furthermore, inorganic binders are divided into non-hydraulic binders and hydraulic binders. Non-hydraulic binders are water-soluble binders such as calcium lime, Dolomitic lime, gypsum and anhydrite, which only cure in air. Hydraulic binders are binders which cure in air and in the presence of water and are water-insoluble after the curing. They include hydraulic limes, cements, and masonry cements. The mixtures of different inorganic binders can also be used in the composition of the present invention.

Additional to the binder or instead of this, the inventive composition can also contain matrix polymers, such as polyolefin resins, e.g. polyethylene or polypropylene, polyester resins, e.g. polyethylene terephthalate, polyacrylonitrile resin, cellulose resin, or a mixture thereof. The inventive fumed silica powder can be incorporated in such matrix polymers or form a coating on the surface thereof.

Apart from the fumed silica powder and the binder, the composition according to the invention can additionally contain at least one solvent and/or filler and/or other additives.

The solvent used in the composition of the invention can be selected from the group consisting of water, alcohols, aliphatic and aromatic hydrocarbons, ethers, esters, aldehydes, ketones and the mixtures thereof. For example, the solvent used can be water, methanol, ethanol, propanol, butanol, pentane, hexane, benzene, toluene, xylene, diethyl ether, methyl tert-butyl ether, ethyl acetate, and acetone. Particularly preferably, the solvents used in the thermal insulating composition have a boiling point of less than 300° C., particularly preferably less than 200° C. Such relatively volatile solvents can be easily evaporated or vaporized during the curing of the composition according to the invention.

The inventive surface modified fumed silica powder is particularly suitable for use in toner compositions.

Use of the Fumed Silica Powder

The inventive surface modified and/or the inventive surface modified silica powder can be used as a constituent of paints or coatings, silicones, pharmaceutical or cosmetic preparations, adhesives or sealants, toner compositions, lithium ion batteries, especially separators, electrodes and/or electrolyte thereof, as well as for modifying rheology properties of liquid systems, as anti-settling agent, for improving flowability of powders, and for improving mechanical or optical properties of silicone compositions.

### EXAMPLES

Analytical Methods.

Specific BET surface area [m²/g] was determined according to DIN 9277:2014 by nitrogen adsorption in accordance with the Brunauer-Emmett-Teller method.

The number of silanol groups relative to BET surface area d_{SiOH} [SiOH/nm²] was determined by reaction of the pre-dried samples of silica powders with lithium aluminium hydride solution as described in detail on page 8, line 17 thru page 9, line 12 of EP 0725037 A1. This method is also described in Journal of Colloid and Interface Science, vol. 125, no. 1, (1988), pp. 61-68.

Tamped density [g/L] was determined according to DIN ISO 787-11:1995 “General methods of test for pigments and extenders—Part 11: Determination of tamped volume and apparent density after tamping”.

Particle size distribution, i.e. values d₁₀, d₉₀, d₉₀ and span (d₉₀−d₁₀)/d₉₀[μm] were measured by static light scattering (SLS) using laser diffraction particle size analyzer (HORIBA LA-950) after 120 s of ultrasonic treatment at 25° C. of a 5% by weight dispersion of the surface treated silica in methanol (for hydrophobic silica powders) or water (for hydrophilic silica powders.

Methanol wettability [vol % of methanol in methanol/water mixture] was determined according to the method described in detail, in WO2011/076518 A1, pages 5-6.

Carbon content [wt. %] was determined by elemental analysis according to EN ISO3262-20:2000 (Chapter 8). The analysed sample was weighed into a ceramic crucible, provided with combustion additives and heated in an induction furnace under an oxygen flow. The carbon present is oxidized to CO₂. The amount of CO₂ gas is quantified by infrared detectors.

Water content [wt. %] was determined by Karl Fischer titration using a Karl Fischer titrator.

Starting Materials.

Aerosil® EG 50 with a BET surface area of 46 m²/g and a tamped density of 117 g/L (manufacturer: Evonik Operations GmbH) was used as starting material 1. Aerosil® 300 with a BET surface area of 282 m²/g and a tamped density of 43 g/L (manufacturer: Evonik Operations GmbH) was used as starting material 2.

### Example 1

Starting material 1 was subjected to thermal treatment in a rotary kiln of ca. 160 mm diameter and 2 m length at 400° C. The mean residence time of the silica in the rotary kiln was 1 hour. Rotational speed was set to 5 rpm resulting in a throughput of approximately 1 kg/h of silica. Dry and filtered compressed air was fed continuously with a flow rate of ca. 1 m³/h to the kiln outlet (in counterflow to the thermally treated silica flow) to provide preconditioned air for the convection in the tube. The process was smooth. No clogging of the rotary kiln was observed. Physico-chemical properties of the obtained thermally treated silica are shown in Table 1.

Examples 2-5 and comparative example 1 were carried out analogously to example 1 but applying thermal treatment temperatures of 700 to 1300° C. No clogging of the rotary kiln was observed in examples 2-5, whereas in comparative example 1, a significant clogging was observed. Physico-chemical properties of the obtained thermally treated silicas are shown in Table 1.

Comparative example 2 was carried out by thermal treatment of the starting material 1 in a chamber kiln (manufacturer: Nabertherm). Layer with a bed of height up to 1 cm was subjected to a thermal treatment at 1200° C. for 1 hour. Physico-chemical properties of the obtained thermally treated silicas are shown in Table 1.

### Example 6

Starting material 2 was subjected to thermal treatment in a rotary kiln of ca. 160 mm diameter and 2 m length at 400° C. The mean residence time of the silica in the rotary kiln was 1 hour. The process was smooth. No clogging of the rotary kiln was observed. Physico-chemical properties of the obtained thermally treated silica are shown in Table 2.

Examples 7-10 and comparative example 3 were carried out analogously to example 6 but applying thermal treatment temperatures of 700 to 1300° C. No clogging of the rotary kiln was observed in examples 7-10, whereas in comparative example 2, a significant clogging was observed. Physico-chemical properties of the obtained thermally treated silicas are shown in Table 2.

Comparative example 4 was carried out by thermal treatment of the starting material 2 in a chamber kiln (manufacturer: Nabertherm). Layer with a bed of height up to 1 cm was subjected to a thermal treatment at 1100° C. for 1 hour. Physico-chemical properties of the obtained thermally treated silicas are shown in Table 1.

### Example 11

Thermally treated hydrophilic silica obtained in example 10 (100 g) was surface treated with hexamethyldisilazan (HMDS). For this purpose, HMDS (8.6 g) was evaporated. Silica powder was heated in a thin layer to 100° C. in a desiccator and then evacuated. Subsequently, vaporized HMDS was admitted into the desiccator until the pressure had risen to 300 mbar. After the sample had been purged with air, it was removed from the desiccator. The thus obtained surface treated silica had a BET surface area of 190 m²/g, carbon content of 1.13%, silanol density of 0.16 SiOH/nm², methanol wettability of 45% methanol in methanol/water mixture, particle size d₉₀ less than 10 μm, as determined by static light scattering (SLS) after 120 s of ultrasonic treatment at 25° C. of a 5% by weight dispersion of the surface treated silica in methanol.

Table 1 shows the physicochemical properties of fumed silica powders obtained by thermal treatment of starting material 1 (BET=46 m²/g, tamped density=117 g/L). BET surface area, tamped density and particle size of the starting material 1 do not change much in examples 1-5, where the thermal treatment is carried out at a temperature of up to 1200° C. Conversely, at a higher temperature of 1300° C. (comparative example 1), an abrupt reduction of the BET surface area and increase of both the tamped density and particle size, e.g. of d₉₀ value, was observed (Table 1). The change of the BET surface area and the particle size was even more pronounced in comparative example 2, where thermal treatment was carried out at 1200° C., but without movement of the silica during the thermal treatment. Silanol group density of the starting material 1 (2.78 OH/nm²) was significantly reduced in examples 1-5 and the comparative example 1, the greatest change taking place in the region 400-1000° C. Interestingly, at a higher temperature of 1300° C. (comparative example 1), no further reducing of the silanol group density could be achieved.

Table 2 summarizes similar as in Table 1 tests (examples 6-10 and comparative examples 3 and 4) but with starting material 2 (BET=282 m²/g, tamped density=43 g/L), the results showing similar trends as those in Table 1.

Thus, carrying out thermal treatment of the hydrophilic fumed silica powders in the temperature range of 400-1200° C. for a specific period of time, while the fumed silica powder being in motion, allowed producing silica powders with relatively low particle size, almost unchanged BET surface area and tamped densities. Such thermally treated silica powders are characterized by a particularly low water content.

Surface treatment of such thermally treated silicas carried out without adding water allows producing of highly hydrophobic silica powders with particularly low silanol group density and water content (example 11).

TABLE 1
Thermal treatment of starting material 1

| | | | | BET [% | | | SiOH | | | | | |
|---|---|---|---|---|---|---|---|---|---|---|---|---|
| | Thermal | Thermal | | of the | tamped | | [% of the | | | | | Water |
| | treatment | treatment | BET | untreated | density | SIOH | untreated | d₁₀* | d₅₀* | d₉₀* | (d₉₀* − | content |
| Sample | [° C.] | time, [h] | [m²/g] | SiO₂] | [g/L] | [OH/nm²] | SiO₂] | [μm] | [μm] | [μm] | d₁₀*)/d₅₀* | [%]** |
| starting | — | — | 46 | 100 | 117 | 2.78 | 100 | 0.05 | 0.16 | 0.51 | 2.88 | 0.46 |
| material 1 | | | | | | | | | | | | |
| example 1 | 400 | 1 | 46 | 100 | 115 | 2.40 | 86.3 | 0.05 | 0.06 | 0.45 | 6.67 | 0.32 |
| example 2 | 700 | 1 | 46 | 100 | 121 | 1.82 | 65.5 | 0.05 | 0.31 | 0.62 | 1.84 | 0.16 |
| example 3 | 1000 | 1 | 46 | 100 | 126 | 1.19 | 42.8 | 0.06 | 0.34 | 0.65 | 1.74 | 0.13 |
| example 4 | 1100 | 1 | 44 | 95.7 | 120 | 1.08 | 38.8 | 0.07 | 0.65 | 0.87 | 1.23 | 0.12 |
| example 5 | 1200 | 1 | 43 | 93.5 | 125 | 1.08 | 38.8 | 0.15 | 0.67 | 0.93 | 1.16 | 0.12 |
| comparative | 1300 | 1 | 33 | 71.7 | 198 | 1.11 | 39.9 | 0.89 | 6.37 | 19.08 | 2.86 | 0.08 |
| example 1 | | | | | | | | | | | | |
| comparative | 1200 | 1 | 29 | 63.0 | | | | 4.73 | 13.99 | 42.61 | 2.71 | 0.05 |
| example 2 | (batch) | | | | | | | | | | | |

*determined by static light scattering (SLS) after 120 s of ultrasonic treatment at 25° C. of a 5% by weight dispersion of the silica in water;
**determined by Karl-Fischer titration.

TABLE 2
Thermal treatment of starting material 2

| | | | | BET [% | | | SiOH | | | | | |
|---|---|---|---|---|---|---|---|---|---|---|---|---|
| | Thermal | Thermal | | of the | tamped | | [% of the | | | | | Water |
| | treatment | treatment | BET | untreated | density | SIOH | untreated | d₁₀* | d₅₀* | d₉₀* | (d₉₀* − | content |
| Sample | [° C.] | time, [h] | [m²/g] | SiO₂] | [g/L] | [OH/nm²] | SiO₂] | [μm] | [μm] | [μm] | d₁₀*)/d₅₀* | [%]** |
| starting | — | — | 282 | 100 | 43 | 1.61 | 100 | 0.08 | 0.14 | 0.38 | 2.14 | 1.09 |
| material 2 | | | | | | | | | | | | |
| example 6 | 400 | 1 | 278 | 98.6 | 41 | 1.34 | 83.2 | 0.07 | 0.11 | 0.20 | 1.18 | 0.60 |
| example 7 | 700 | 1 | 275 | 97.5 | 42 | 1.22 | 75.8 | 0.08 | 0.14 | 0.34 | 1.86 | 0.39 |
| example 8 | 1000 | 1 | 259 | 91.8 | 41 | 1.03 | 64.0 | 0.08 | 0.17 | 0.61 | 3.12 | 0.17 |
| example 9 | 1100 | 1 | 233 | 82.6 | 41 | 0.99 | 61.5 | 0.08 | 0.15 | 0.40 | 2.13 | 0.13 |
| example 10 | 1200 | 1 | 186 | 66.0 | 43 | 0.74 | 46.0 | 0.10 | 0.26 | 4.19 | 15.73 | 0.11 |
| comparative | 1300 | 1 | 94 | 51.6 | 110 | 0.94 | 58.4 | 5.53 | 11.48 | 20.38 | 1.29 | 0.09 |
| example 3 | | | | | | | | | | | | |
| comparative | 1100 | 1 | 162 | 57.4 | | | | 0.11 | 0.32 | 87.87 | 274.25 | |
| example 4 | (batch) | | | | | | | | | | | |

*determined by static light scattering (SLS) after 120 s of ultrasonic treatment at 25° C. of a 5% by weight dispersion of the silica in water;
**determined by Karl-Fischer titration.

1. Process for producing fumed silica powder, comprising
step A)—subjecting a surface untreated fumed silica powder, which have not been surface modified by treatment with any surface treatment agents, with a number of silanol groups relative to BET surface area d_{SiOH} of at least 1.2 SiOH/nm², as determined by reaction with lithium aluminium hydride and a particle size d₉₀ of not more than 10 μm, as determined by a static light scattering method in a 5% by weight aqueous dispersion of the silica after 120 seconds of ultrasonic treatment at 25° C., to thermal treatment at a temperature of 350° C. to 1250° C. for 5 min to 5 h,
wherein the temperature and the duration of the thermal treatment are chosen so that d_{SiOH} of the silica is decreased by 10%-70% relative to d_{SiOH} of the employed thermally and surface untreated fumed silica powder,
wherein the thermal treatment is carried out while the fumed silica powder is in motion.

2. Process according to claim 1,
wherein the silica is being moved with a motion rate of at least 1 cm/min during the thermal treatment step A).

3. Process according to claim 1,
wherein no water is added before, during or after carrying out step A).

4. Process according to claim 1, wherein
the thermal treatment is carried out in a rotary kiln.

5. Process for producing fumed silica powder according to claim 1, further comprising
step B)—surface treatment of the of the fumed silica powder obtained in step A) with a surface treatment agent selected from the group consisting of organosilanes, silazanes, acyclic polysiloxanes, cyclic polysiloxanes, and mixtures thereof.

6. Process according to claim 5, wherein water is added in amounts less than 1% by weight of the employed fumed silica powder, before, during or after carrying out step B)

7. Surface unmodified fumed silica powder having:
a) a number of silanol groups relative to BET surface area d_{SiOH} of not more than 1.17 SiOH/nm², as determined by reaction with lithium aluminium hydride;
b) particle size d₉₀ of not more than 10 μm, as determined by a static light scattering method in a 5% by weight aqueous dispersion of the silica after 120 seconds of ultrasonic treatment at 25° C.

8. Fumed silica powder according to claim 7, wherein the silica powder has a span of particle size distribution (d₉₀−d₁₀)/d₅₀ of 0.8 to 3.5, as determined by static light scattering after 120 s of ultrasonic treatment at 25° C. of a 5% by weight dispersion of the silica in water.

9. Fumed silica powder according to claim 7, wherein the silica powder has a tamped density of 30 g/L to 150 g/L.

10. Fumed silica powder according to claim 7, wherein the silica powder is obtained by the process comprising:
step A)—subjecting a surface untreated fumed silica powder, which have not been surface modified by treatment with any surface treatment agents, with a number of silanol groups relative to BET surface area d_{SiOH} of at least 1.2 SiOH/nm², as determined by reaction with lithium aluminum hydride and a particle size d₉₀ of not more than 10 μm, as determined by a static light scattering method in a 5% by weight aqueous dispersion of the silica after 120 seconds of ultrasonic treatment at 25° C.,
to thermal treatment at a temperature of 350° C. to 1250° C. for 5 min to 5 h,
wherein the temperature and the duration of the thermal treatment are chosen so that d_{SiOH} of the silica is decreased by 10%-70% relative to d_{SiOH} of the employed thermally and surface untreated fumed silica powder,
wherein the thermal treatment is carried out while the fumed silica powder is in motion.

11. Surface modified fumed silica powder having:
a) a number of silanol groups relative to BET surface area d_{SiOH} of not more than 0.29 SiOH/nm², as determined by reaction with lithium aluminium hydride;
b) particle size d₉₀ of not more than 10 μm, as by a static light scattering method in a 5% by weight dispersion of the silica in methanol after 120 seconds of ultrasonic treatment at 25° C.

12. Fumed silica powder according to claim 11, wherein carbon content of the surface modified silica is 0.5% to 3.5% by weight.

13. Fumed silica powder according to claim 11 obtained by the process comprising:
step A)—subjecting a surface untreated fumed silica powder, which have not been surface modified by treatment with any surface treatment agents, with a number of silanol groups relative to BET surface area d_{SiOH} of at least 1.2 SiOH/nm2, as determined by reaction with lithium aluminum hydride and a particle size d90 of not more than 10 μm, as determined by a static light scattering method in a 5% by weight aqueous dispersion of the silica after 120 seconds of ultrasonic treatment at 25° C.,
to thermal treatment at a temperature of 350° C. to 1250° C. for 5 min to 5 h,
wherein the temperature and the duration of the thermal treatment are chosen so that d_{SiOH} of the silica is decreased by 10%-70% relative to d_{SiOH} of the employed thermally and surface untreated fumed silica powder,
wherein the thermal treatment is carried out while the fumed silica powder is in motion,
step B)—surface treatment of the of the fumed silica powder obtained in step A) with a surface treatment agent selected from the group consisting of organosilanes, silazanes, acyclic polysiloxanes, cyclic polysiloxanes, and mixtures thereof.

14. Composition comprising the fumed silica powder according to claim 7.

15. A method comprising
adding fumed silica powder according to claim 7 as a constituent of paints or coatings, silicones, pharmaceutical or cosmetic preparations, adhesives or sealants, toner compositions, lithium-ion batteries, or
adding fumed silica powder according to claim 7 to liquid systems to modify rheologic properties or
adding fumed silica powder according to claim 7 to liquid systems as an anti-settling agent, or
adding fumed silica powder according to claim 7 to powders to improve flowability, or
adding fumed silica powder according to claim 7 to silicone compositions to improve mechanical or optical properties.
